(19) United States
(12) Patent Application Publication
(10) Pub. No.: US 2026/0205789 A1
(43) Pub. Date: Jul. 16, 2026

(54) CONFIGURING A TERMINAL APPARATUS FOR A NETWORK EMERGENCY TECHNICAL FIELD

(71) Applicant: Nokia Technologies Oy, Espoo (FI)

(72) Inventors: Laura Luque SANCHEZ, Aalborg (DK); Daniela LASELVA, Aalborg (DK); Mads LAURIDSEN, Aalborg (DK); Jorma Johannes KAIKKONEN, Oulu (FI)

(21) Appl. No.: 19/136,611

(22) PCT Filed: Nov. 6, 2023
(86) PCT No.: PCT/EP2023/080804

§ 371 Date: Jun. 6, 2025

(30) Foreign Application Priority Data
Dec. 8, 2022 (FI) 20226085

(51) Int. Cl. H04W 4/90; H04W 36/04; H04W 72/11; H04W 76/20

(52) U.S. Cl. CPC H04W 4/90; H04W 36/04; H04W 72/11; H04W 76/20

(57) ABSTRACT

According to an aspect, there is provided a terminal apparatus that may receive a network emergency mode configuration, the network emergency mode configuration indicating at least one reduced operation mode to be applied in response to an activation indication. The terminal device may apply the at least one reduced operation mode for network signaling based on the network emergency mode configuration.

Various example embodiments generally relate to the field of telecommunication systems. In particular, some example embodiments relate to a solution for configuring a terminal apparatus for a network emergency associated with a wireless communication network.

### BACKGROUND

Various kinds of emergency situations and disasters may happen that have an effect on wireless telecommunication networks and their ability to provide wireless service. Natural disasters, such as earthquakes, tsunamis, volcano eruptions, hurricanes, etc. and other type of disasters (for example, human-made, fires etc.) may sometimes be predictable and some other times they cannot be predicted.

Wireless communication in the emergency situations and disasters becomes critical, for example, for people, rescue teams and first responders when helping the people who are affected. For example, people would need to perform emergency calls, inform about their locations, get information regarding the state of the disaster, roads, hospitals or spots to seek for help. At the same time, citizens would like to get in contact with their loved ones to inform them and also make sure that they are fine.

However, there is a high risk of a loss of electricity grid supply to network devices, for example, base stations enabling the wireless communication, and it may take up to several days to solve in case of the loss of electricity grid supply. In such cases, a base station may still function using a back-up power supply (for example, a diesel generator, batteries etc.). However, the back-up power supply is usually able to provide the back-up power only for a very limited time, typically from 15 minutes to a few hours. Further, the back-up power supply based operation may limit the maximum instantaneous current that can be drawn from the back-up power supply. This effectively limits the peak power that the base station is allowed to consume. This may also mean, for example, that certain transmissions requiring higher power levels cannot be made by an affected base station. This also means that there is no transition time available to gradually change the operation mode once the back-up power supply based operation has been initiated. Finally, once the back-up power supply is empty, the base station will have to power off, leading to situations in which, although the need of connectivity is higher than ever, no one is any more able to communicate wirelessly.

A network could reconfigure itself and switch to a “power-loss mode” in order to become as power efficient as possible after detecting an emergency situations. If the network switched to the power-loss mode, it would need to reconfigure all UEs in the network to understand the new configuration. However, this would be very inefficient, i.e. time and energy consuming. For example, a reconfiguration of the system information may take minutes depending on a current configuration of the network.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution that enables a timely and efficient switch to low power mode in case of emergency situation associated with a network apparatus, for example, a base station. This benefit may be achieved by the features of the independent claims. Further implementation forms are provided in the dependent claims, the description, and the drawings.

According to a first aspect, a terminal apparatus may comprise at least one processor and at least one memory storing instructions, that when executed by the at least one processor, cause the terminal apparatus to perform: receiving a network emergency mode configuration, the network emergency mode configuration indicating at least one reduced operation mode to be applied in response to an activation indication; and applying the at least one reduced operation mode for network signaling based on the network emergency mode configuration.

In an example embodiment of the first aspect, the instructions, when executed by the at least one processor, cause the terminal apparatus to perform: receiving the network emergency mode configuration via dedicated radio resource control signaling or a system information broadcast.

In an example embodiment of the first aspect, the instructions, when executed by the at least one processor, cause the terminal apparatus to perform: receiving the activation indication associated with the network emergency mode configuration; and applying the network emergency mode configuration based on the activation indication.

In an example embodiment of the first aspect, the network emergency mode configuration comprises the activation indication or the network emergency mode configuration acts as the activation indication.

In an example embodiment of the first aspect, the network emergency mode configuration comprises at least one of: information relating to terminal apparatus controlled L1 and/or L3 mobility; information relating to a primary cell operation only and a secondary cell de-configuration or de-activation; information relating to a cell-wise connected mode discontinuous reception configuration of the terminal apparatus; information relating to a cell discontinuous reception or transmission pattern; information relating to a configured grant/semi-persistent scheduling configurations; information relating to voice and small data transmission only mode; and information relating to immediate and implicit suspension or release of the radio resource control connection.

In an example embodiment of the first aspect, the instructions, when executed by the at least one processor, cause the terminal apparatus to perform at least one of the following based on the presence of the corresponding information in the network emergency mode configuration: applying terminal apparatus controlled L1 and/or L3 mobility in response to the information relating to terminal apparatus controlled L1 and/or L3 mobility; de-configuring or deactivating all configured secondary cells in response to the information relating to a primary cell operation only and a secondary cell de-configuration or de-activation; applying a cell-wise connected mode discontinuous reception configuration in response to the information relating to a cell-wise connected mode discontinuous reception configuration of the terminal apparatus; applying a cell discontinuous reception or transmission pattern in response to the information relating to a cell discontinuous reception or transmission pattern; discarding all semi-persistent resources for the UE and configured grant and semi-persistent scheduling configurations in response to the information relating to a configured grant and semi-persistent scheduling configurations; applying voice and small data transmission only mode in response to the information relating to voice and small data transmission only mode; and releasing the radio resource control connection in response to the information relating to immediate and implicit suspension or release of the radio resource control connection, and moving to an inactive or idle state.

In an example embodiment of the first aspect, the instructions, when executed by the at least one processor, cause the-terminal apparatus to perform: omitting reception or discarding configuration of the paging early indication signal and/or the tracking reference signal when the terminal apparatus is a radio resource control idle or inactive state.

In an example embodiment of the first aspect, the network emergency mode configuration comprises at least one of: an indication of at least one affected cell and cell availability period information of the at least one affected cell, and an indication that at least one frequency layer is unavailable and unavailability information when the at least one frequency layer is unavailable.

In an example embodiment of the first aspect, the instructions, when executed by the at least one processor, cause the terminal apparatus to perform: limiting network signaling in accordance with the cell availability period information when an affected cell was the last serving cell of the terminal apparatus.

In an example embodiment of the first aspect, the instructions, when executed by the at least one processor, cause the terminal apparatus to perform: applying a random delay for setting up a connection with a target cell in the beginning of the cell availability period.

In an example embodiment of the first aspect, the instructions, when executed by the at least one processor, cause the terminal apparatus to perform at least one of: omitting measurements of the at least one affected cell and cell detections for the at least one affected cell outside the cell availability period, and omitting measurements of the at least one frequency layer based on the unavailability information.

In an example embodiment of the first aspect, the network emergency mode configuration is cell specific.

In an example embodiment of the first aspect, the network emergency mode configuration is cell type specific.

In an example embodiment of the first aspect, the network emergency mode configuration is frequency layer specific.

In an example embodiment of the first aspect, the network emergency mode configuration comprises a general network emergency mode configuration and a cell specific network emergency mode configuration.

According to a second aspect, a network apparatus may comprise at least one processor and at least one memory storing instructions, that when executed by the at least one processor, cause the network apparatus to perform: transmitting a network emergency mode configuration to a terminal apparatus, the network emergency mode configuration indicating at least one reduced operation mode to be applied in response to an activation indication; and applying the at least one reduced operation mode based on the network emergency mode configuration.

In an example embodiment of the second aspect, the instructions, when executed by the at least one processor, cause the network apparatus to perform: transmitting the activation indication associated with the network emergency mode configuration; and applying the network emergency mode configuration in response to transmitting the activation indication.

In an example embodiment of the second aspect, the network emergency mode configuration comprises the activation indication or the network emergency mode configuration acts as the activation indication.

In an example embodiment of the second aspect, the instructions, when executed by the at least one processor, cause the network apparatus to perform: discarding transmission of the paging early indication signal and/or the tracking reference signal for a terminal apparatus being in a radio resource control idle or inactive state.

In an example embodiment of the second aspect, the network emergency mode configuration comprises at least one of: information relating to terminal apparatus controlled L1 and/or L3 mobility; information relating to a primary cell operation only and a secondary cell de-configuration or de-activation; information relating to a cell-wise connected mode discontinuous reception configuration of the terminal apparatus; information relating to a cell discontinuous reception or transmission pattern; information relating to a configured grant/semi-persistent scheduling configurations; information relating to voice and small data transmission only mode; and information relating to immediate and implicit suspension or release of the radio resource control connection.

In an example embodiment of the second aspect, the network emergency mode configuration comprises at least one of: an indication of at least one affected cell and cell availability period information of the at least one affected cell, and an indication that at least one frequency layer is unavailable and unavailability information when the at least one frequency layer is unavailable.

In an example embodiment of the second aspect, the instructions, when executed by the at least one processor, cause the network apparatus to perform: switching off network services outside the cell availability period.

In an example embodiment of the second aspect, the instructions, when executed by the at least one processor, cause the network apparatus to perform: barring network access for terminal apparatuses outside the cell availability period based on at least one terminal apparatus class.

In an example embodiment of the second aspect, the instructions, when executed by the at least one processor, cause the network apparatus to perform: applying a first transmission power level during a first part of the cell availability period; determining, based on measurement reports from terminal apparatuses, a second transmission power level to be used during a second part of the cell availability period; and applying the second transmission power level during the second part of the cell availability period.

In an example embodiment of the second aspect, the instructions, when executed by the at least one processor, cause the network apparatus to perform: transmitting access barring information associated with the network emergency mode configuration to the terminal apparatus.

In an example embodiment of the second aspect, the instructions, when executed by the at least one processor, cause the network apparatus to perform: applying the access barring information and unified access control when network access is available.

In an example embodiment of the second aspect, the network emergency mode configuration is cell specific.

In an example embodiment of the second aspect, the network emergency mode configuration is cell type specific.

In an example embodiment of the second aspect, the network emergency mode configuration is frequency layer specific.

In an example embodiment of the second aspect, the network emergency mode configuration comprises a general network emergency mode configuration and a cell specific network emergency mode configuration.

According to a third aspect, a method comprises receiving, by a terminal apparatus, a network emergency mode configuration, the network emergency mode configuration indicating at least one reduced operation mode to be applied in response to an activation indication; and applying, by the terminal apparatus, the at least one reduced operation mode for network signaling based on the network emergency mode configuration.

In an example embodiment of the third aspect, the method further comprises receiving the network emergency mode configuration via dedicated radio resource control signaling or a system information broadcast.

In an example embodiment of the third aspect, the method further comprises receiving, by the terminal apparatus, the activation indication associated with the network emergency mode configuration; and applying, by the terminal apparatus, the network emergency mode configuration based on the activation indication.

In an example embodiment of the third aspect, the network emergency mode configuration comprises the activation indication or the network emergency mode configuration acts as the activation indication.

In an example embodiment of the third aspect, the network emergency mode configuration comprises at least one of: information relating to terminal apparatus controlled L1 and/or L3 mobility; information relating to a primary cell operation only and a secondary cell de-configuration or de-activation; information relating to a cell-wise connected mode discontinuous reception configuration of the terminal apparatus; information relating to a cell discontinuous reception or transmission pattern; information relating to a configured /ant/ semi-persistent scheduling configurations; information relating to voice and small data transmission only mode; and information relating to immediate and implicit suspension or release of the radio resource control connection.

In an example embodiment of the third aspect, the method further comprises at least one of the following based on the presence of the corresponding information in the network emergency mode configuration: applying, by the terminal apparatus, terminal apparatus controlled L1 and/or L3 mobility in response to the information relating to terminal apparatus controlled L1 /d/ or L3 mobility; de-configuring or deactivating, by the terminal apparatus, all configured secondary cells in response to the information relating to a primary cell operation only and a secondary cell de-configuration or de-activation; applying, by the terminal apparatus, a cell-wise connected mode discontinuous reception configuration in response to the information relating to a cell-wise connected mode discontinuous reception configuration of the terminal apparatus; applying a cell discontinuous reception or transmission pattern in response to the information relating to a cell discontinuous reception or transmission pattern; discarding, by the terminal apparatus, all semi-persistent resources for the UE and configured grant and semi-persistent scheduling configurations in response to the information relating to a configured grant and semi-persistent scheduling configurations; applying, by the terminal apparatus, voice and small data transmission only mode in response to the information relating to voice and small data transmission only mode; and releasing, by the terminal apparatus, the radio resource control connection in response to the information relating to immediate and implicit suspension or release of the radio resource control connection, and moving to an inactive or idle state.

In an example embodiment of the third aspect, the method further comprises omitting reception or discarding configuration of the paging early indication signal and/or the tracking reference signal when the terminal apparatus is a radio resource control idle or inactive state.

In an example embodiment of the third aspect, the network emergency mode configuration comprises at least one of: an indication of at least one affected cell and cell availability period information of the at least one affected cell, and an indication that at least one frequency layer is unavailable and unavailability information when the at least one frequency layer is unavailable.

In an example embodiment of the third aspect, the method further comprises limiting, by the terminal apparatus, network signaling in accordance with the cell availability period information when an affected cell was the last serving cell of the terminal apparatus.

In an example embodiment of the third aspect, the method further comprises applying a random delay for setting up a connection with a target cell in the beginning of the cell availability period.

In an example embodiment of the third aspect, the method further comprises at least one of: omitting measurements of the at least one affected cell and cell detections for the at least one affected cell outside the cell availability period, and omitting measurements of the at least one frequency layer based on the unavailability information.

In an example embodiment of the third aspect, the network emergency mode configuration is cell specific.

In an example embodiment of the third aspect, the network emergency mode configuration is cell type specific.

In an example embodiment of the third aspect, the network emergency mode configuration is frequency layer specific.

In an example embodiment of the third aspect, the network emergency mode configuration comprises a general network emergency mode configuration and a cell specific network emergency mode configuration.

According to a fourth aspect, a method comprises transmitting, by a network apparatus, a network emergency mode configuration to a terminal apparatus, the network emergency mode configuration indicating at least one reduced operation mode to be applied in response to an activation indication; and applying, by the network apparatus, the at least one reduced operation mode based on the network emergency mode configuration.

In an example embodiment of the fourth aspect, the method further comprises transmitting, by the network apparatus, the activation indication associated with the network emergency mode configuration; and applying, by the network apparatus, the network emergency mode configuration in response to transmitting the activation indication.

In an example embodiment of the fourth aspect, the network emergency mode configuration comprises the activation indication or the network emergency mode configuration acts as the activation indication.

In an example embodiment of the fourth aspect, the method further comprises discarding, by the network apparatus, transmission of the paging early indication signal and/or the tracking reference signal for a terminal apparatus being in a radio resource control idle or inactive state.

In an example embodiment of the fourth aspect, the network emergency mode configuration comprises at least one of: information relating to terminal apparatus controlled L1 and/or L3 mobility; information relating to a primary cell operation only and a secondary cell de-configuration or de-activation; information relating to a cell-wise connected mode discontinuous reception configuration of the terminal apparatus; information relating to a cell discontinuous reception or transmission pattern; information relating to a configured grant/semi-persistent scheduling configurations; information relating to voice and small data transmission only mode; and information relating to immediate and implicit suspension or release of the radio resource control connection.

In an example embodiment of the fourth aspect, the network emergency mode configuration comprises at least one of: an indication of at least one affected cell and cell availability period information of the at least one affected cell, and an indication that at least one frequency layer is unavailable and unavailability information when the at least one frequency layer is unavailable.

In an example embodiment of the fourth aspect, the method further comprises switching off, by the network apparatus, network services outside the cell availability period.

In an example embodiment of the fourth aspect, the method further comprises barring, by the network apparatus, network access for terminal apparatuses outside the cell availability period based on at least one terminal apparatus class.

In an example embodiment of the fourth aspect, the method further comprises applying, by the network apparatus, a first transmission power level during a first part of the cell availability period; determining, by the network apparatus, based on measurement reports from terminal apparatuses, a second transmission power level to be used during a second part of the cell availability period; and applying, by the network apparatus, the second transmission power level during the second part of the cell availability period.

In an example embodiment of the fourth aspect, the method further comprises transmitting access barring information associated with the network emergency mode configuration to the terminal apparatus.

In an example embodiment of the fourth aspect, the method further comprises applying the access barring information and unified access control when network access is available.

In an example embodiment of the fourth aspect, the network emergency mode configuration is cell specific.

In an example embodiment of the fourth aspect, the network emergency mode configuration is cell type specific.

In an example embodiment of the fourth aspect, the network emergency mode configuration is frequency layer specific.

In an example embodiment of the fourth aspect, the network emergency mode configuration comprises a general network emergency mode configuration and a cell specific network emergency mode configuration.

According to a fifth aspect a computer program comprises instructions for causing an apparatus to carry out the method of the third aspect.

According to a sixth aspect a computer program comprises instructions for causing an apparatus to carry out the method of the fourth aspect.

According to a seventh aspect a computer readable medium comprises a computer program comprising instructions for causing an apparatus to carry out the method of the third aspect.

According to an eighth aspect a computer readable medium comprises a computer program comprising instructions for causing an apparatus to carry out the method of the fourth aspect.

According to a ninth aspect, an apparatus may comprise means for: receiving a network emergency mode configuration, the network emergency mode configuration indicating at least one reduced operation mode to be applied in response to an activation indication; and applying the at least one reduced operation mode for network signaling based on the network emergency mode configuration.

According to a tenth aspect, an apparatus may comprise means for: transmitting a network emergency mode configuration to a terminal apparatus, the network emergency mode configuration indicating at least one reduced operation mode to be applied in response to an activation indication; and applying the at least one reduced operation mode based on the network emergency mode configuration.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates a system according to an example embodiment.

FIG. 2A illustrates an example of a method according to an example embodiment.

FIG. 2B illustrates an example of a method according to an example embodiment.

FIG. 3A illustrates a flow diagram according to an example embodiment.

FIG. 3B illustrates a flow diagram according to an example embodiment.

FIG. 4 illustrates a flow diagram for a terminal apparatus according to an example embodiment.

FIG. 5 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

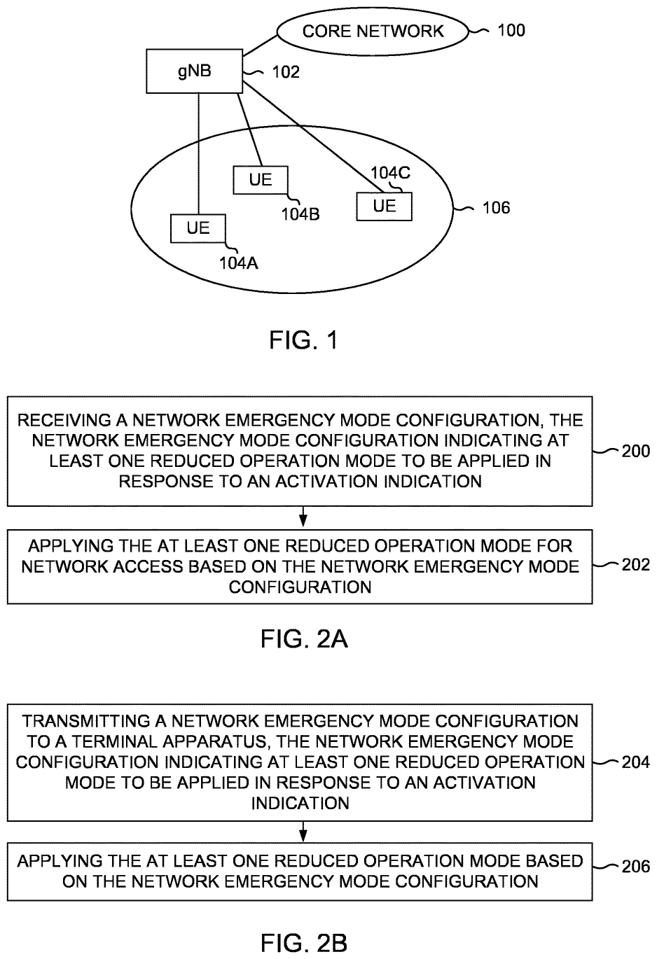

FIG. 1 illustrates a system according to an example embodiment. The system may comprise one or more network apparatuses 102 connected to a core network 100. The network apparatus 102 may be a 5G base station, i.e. a gNB. The network apparatus 102 may provide one or more cells 106 to serve terminal apparatuses 104A-104C, i.e. user equipment (UE).

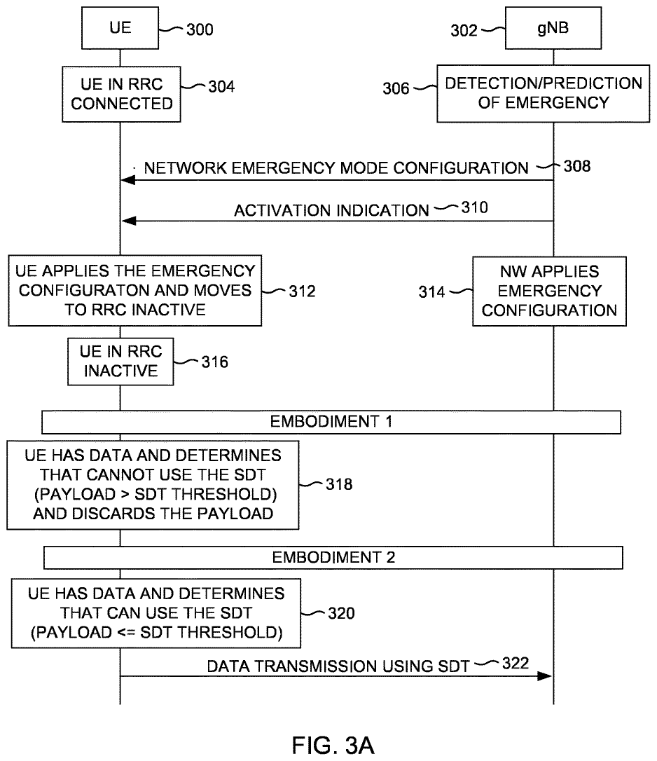

FIG. 2A illustrates an example of a method according to an example embodiment. The method may be implemented by a terminal apparatus, for example, user equipment wirelessly connected to a network apparatus, for example, a base station or a gNB.

At 200 a network emergency mode configuration may be received, for example, from a base station. The network emergency mode configuration indicates least one reduced operation mode to be applied in response to an activation indication. The network emergency may refer to a situation in which a network apparatus, for example, a base station or gNB, is not any more able to provide a normal service to UEs due to, for example, the loss of electricity grid supply to one or more gNBs. In an example embodiment, the terminal apparatus may be in a radio resource control connected mode when receiving the network emergency mode configuration. In an example embodiment, the UE may receive the network emergency mode configuration as dedicated radio resource control (RRC) signaling, for example, together with the first RRC configuration. In another example embodiment, UE may receive the network emergency mode configuration via a system information broadcast (this can be received by the UE independently of the RRC state). In another example embodiment, the network emergency mode configuration may be provided to the UE based on disaster prediction likelihood and only for affected base stations, for example, gNBs. In this case, the network emergency mode configuration may be provided to the UE together with the first RRC configuration and in the system information block (SIB). The network emergency mode configuration may be provided to the UE prior to the network emergency or just after the network emergency has been declared.

At 202 the at least one reduced operation mode may be applied by the UE for network signaling based on the network emergency mode configuration. The term network signaling may refer to receiving signaling from a network, transmitting signals to the network or both.

The emergency mode configuration may comprise at least one of the following:
Information relating to UE controlled L1 and/or L3 mobility. In other words, the UE falls back to UE-controlled mobility in respect to both beam-level mobility and cell-level mobility, despite being in the RRC connected state. The UE may ignore measurement report configuration (for example, no radio resource management (RRM) measurement report nor L1-RSRP (Reference Signal Received Power) reporting for beam management. The UE may be configured to send an indication to the gNB for cell reselection/RRC release, upon determining the decision to reselecting to a new cell (gNB response is not needed). The indication can be sent as L1/L2/L3 signaling using, for example, a UE specific Physical Random Access Channel (PRACH) resource dedicated to this purpose, or UE assistance information (UAI). The UE may be configured to omit radio link failure (RLF) reporting.
Information relating to a primary cell operation only and a secondary cell de-configuration or de-activation. In other words, the UE in the RRC connected state should consider all SCells de-configured/de-activated at once, and there is no service/communication via the secondary cell.
Information relating to a cell-wise connected mode discontinuous reception (C-DRX) configuration. (i.e. whether the UE in the RRC connected state should overwrite its UE-specific C-DRX configuration with the cell-specific one). Further, in the C-DRX configuration all UEs now apply the same DRX configuration (it can be DRX for Idle UEs and/or DRX for Connected UEs).
Information relating to a cell discontinuous reception (DRX) or cell discontinuous transmission (DTX) pattern. The cell DRX and/or cell DTX may apply to any signal or subset of signals, for example, network configured signals.
Information relating to a configured grant (CG)/semi-persistent scheduling (SPS) configurations. For example, the UE may be configured to discard all semi-persistent resources for the UE, including discarding all or selected CSI-RS configurations of the UE, and discarding of all CG and SPS configurations of the UE.
Information relating to voice and small data transmission (SDT) only mode. For uplink (UL) payload exceeding the SDT data amount threshold (either the legacy threshold or a dedicated threshold for emergency), the UE cannot initiate access to the network. For downlink (DL), the gNB will discard payloads larger than a network internal data amount threshold. In case of voice call, the UE is allowed to start an ordinary connection, i.e. the UE can perform the call.
Information relating to immediate and implicit suspension or release of the radio resource control connection. This may be done without an explicit RRC release message, and the UE moves to the radio resource control idle or inactive state. If the network emergency mode configuration comprises a suspend configuration, the UE may be configured to move to the inactive state, and otherwise to the idle state.

In response to the network emergency mode configuration, the UE may be configured to perform at least one of the following actions based on the presence of the corresponding information in the network emergency mode configuration:
applying UE controlled L1 and/or L3 mobility in response to the information relating to UE controlled L1 and/or L3 mobility;
de-configuring or deactivating all configured secondary cells in response to the information relating to a primary cell operation only and a secondary cell de-configuration or de-activation;
applying a cell-wise connected mode discontinuous reception configuration in response to the information relating to a cell-wise connected mode discontinuous reception configuration of the terminal apparatus;
applying a cell discontinuous reception or transmission pattern in response to the information relating to a cell discontinuous reception or transmission pattern;
discarding all semi-persistent resources for the UE and configured grant and semi-persistent scheduling configurations in response to the information relating to a configured grant and semi-persistent scheduling configurations;
applying voice and small data transmission only mode in response to the information relating to voice and small data transmission only mode; and
releasing the radio resource control connection in response to the information relating to immediate and implicit suspension or release of the radio resource control connection, and moving to an inactive or idle state.

The UE may apply the network emergency mode configuration, when the network emergency mode configuration is first received and then subsequently activated. In another example embodiment, the UE may apply the network emergency mode configuration, when the network emergency mode configuration and the activation indication are received simultaneously. Yet another example embodiment, the UE may receive as part of the network emergency mode configuration or as a separate transmission, at least one condition when to apply the network emergency mode configuration. The at least one condition may comprise, for example, a time, a timer, and/or a detection of a certain network behavior. For example, an emergency may be predicted to happen in one hour from now, or today at 17:00 UTC etc. Then, when the at least one condition is fulfilled, the UE will apply the network emergency mode configuration.

In an example embodiment, the UE may be configured to receive an activation indication associated with the network emergency mode configuration, and apply the network emergency mode configuration based on the activation indication. In an example embodiment, gNB may be configured to send the activation indication, for example, in the paging downlink control information (DCI) short message to enable the network emergency mode configuration. For example, a spare bit in the DCI short message may be used for this. In another example embodiment, the activation of the network emergency mode configuration may be indicated in the system information block type 1 (SIB1 ) or in the master information block (MIB) so that new UEs entering a cell are aware of the current cell configuration. The paging DCI or the SIB may carry, for example, an earthquake and tsunami warning system (ETWS) notification, which can be used as a trigger for applying the network emergency mode configuration. Once the network emergency mode configuration is enabled by the activation indication, it can remain active until a new explicit indication that disables the network emergency mode configuration is received by the UE. In another example embodiment, the network emergency mode configuration may comprise the activation indication or the network emergency mode configuration may act as the activation indication, and thus the activation indication may be implicit. In other words, the network emergency mode configuration may explicitly comprise the activation indication or the network emergency mode configuration itself may act as an implicit activation indication without separately receiving or detecting the activation indication.

In an example embodiment, upon reception of the activation indication from the gNB, the UE may be configured to store the current configuration before switching to the network emergency mode configuration. The UE may then apply the stored configuration once the network emergency mode configuration has been disabled.

In an example embodiment, the network emergency mode configuration may comprise at least one of an indication of at least one affected cell and cell availability period information of the at least one affected cell, and an indication that at least one frequency layer is unavailable and unavailability information when the at least one frequency layer is unavailable. For example, the UE may be configured to limit network signaling in accordance with cell availability period information when an affected cell was the last serving cell of the UE. The affected cells may be indicated to the UE with an emergency cell list. In an example embodiment, the UE may be configured to omit measurements of the at least one affected cell and cell detections for the at least one affected cell outside the cell availability period, and/or omit measurements of the at least one frequency layer based on the unavailability information. The cell availability period information may indicate a time interval t1-t2 during which network access or network signaling is allowable. The time interval t1-t2 may be, for example, 5 minutes in every 30 minutes or 5 minutes in every 60 minutes or any other applicable time interval. The UE served by the affected cell will then postpone network access or network signaling until the next time interval t1-t2, and sleep outside the time intervals t1-t2. When the network is available again, the UE may be configured to first search for the last serving cell. Similarly, the UE may perform measurements only from time t1 to t2, and may remain in a power saving mode (PSM) for the rest of the time. In an example embodiment, the UE may be configured to implicitly release itself from a connected mode when the time interval expires without attempting to recover from a radio link failure (RLF). A UE in the RRC idle/inactive state may be configured to also stop cell search and paging monitoring.

In an example embodiment, the gNB may be configured to indicate if the SIB has changed since last network availability period, and if there is no change, the UE can attempt network access or network signaling without reading the SIB. For example, the valueTag parameter may be used to indicate whether SIB has changed.

The use of cell availability periods may enable a tradeoff in which the network still allows to transfer simple messages once per hour, and at the same time the battery duration both at the UE and the gNB is extended.

In case there is a large number of UEs in the same affected cell, this may mean that different terminal devices may initiate network access or network signaling once the next time interval t1-t2 starts. In an example embodiment, in order to avoid congestion when the network is again available, the network access, network signaling of the UEs or setting up a connection with a target cell with the UE can be randomized in the beginning of the time interval t1-t2 so each UE may be configured to access the network at the start time t1 added with a random delay. This may then distribute the load from the UEs such that the random access channel (RACH) capacity is sufficient. For example, the random delay may be uniform between 1 and 15 seconds, and thus the number of UEs accessing the network for the first 15 second of the interval t1-t2 is spread. In an example embodiment, some terminal devices may be assigned contention-free random access (CFRA) resources in the previous network availability time, and when the next availability time, i.e. the next time interval t1-t2, starts and the network becomes available again, these UEs may use the CFRA. This may be useful for stationary terminal devices, which are known to be in need of network connectivity at the next network availability time.

An advantage of the solution discussed above relating to FIG. 2A is that the network can activate the network emergency mode configuration in a timely and efficient manner when a network emergency occurs or is imminent, leading to a power outage which limits the availability/capabilities of the network to provide service. During this network emergency mode configuration, the network will operate with reduced functionalities to minimize the energy consumed by network and UEs with the aim to extend the network service provisioning time. This may provide a solution in which the network is able to provide a relatively poorer service for a longer time rather than a better service for a shorter time.

FIG. 2B illustrates an example of a method according to an example embodiment. The method may be implemented by a network apparatus, for example, a base station or a gNB.

At 208 a network emergency mode configuration may be transmitted to a UE. The UE may be in a radio resource control connected mode. The network emergency mode configuration indicates at least one reduced operation mode to be applied in response to an activation indication. The network emergency may refer to a situation in which the gNB is not any more able to provide a normal service to UEs, for example, user equipment due to, for example, the loss of electricity grid supply. In an example embodiment, the network emergency mode configuration may be provided to the UE together with the first radio resource control (RRC) configuration or in a system information block (SIB). In another example embodiment, the network emergency mode configuration may be provided to the UE based on disaster prediction likelihood and only for affected base stations, for example, gNBs. In this case, the network emergency mode configuration may be provided to the UE together with the first RRC configuration and in the system information block (SIB). The network emergency mode configuration may be provided to the UE prior to the network emergency or just after the network emergency has been declared.

At 210 the at least one reduced operation mode may be applied based on the network emergency mode configuration.

The network emergency mode configuration may comprise at least one of the following:
Information relating to UE controlled L1 and/or L3 mobility. In other words, the UE falls back to UE-controlled mobility in respect to both beam-level mobility and cell-level mobility, despite being in the RRC connected state. The UE be configured to may ignore measurement report configuration (for example, no radio resource management (RRM) measurement report nor L1-RSRP (Reference Signal Received Power) reporting for beam management. The UE may send an indication to the gNB for cell reselection/RRC release, upon determining the decision to reselecting to a new cell (gNB response is not needed). The indication may be sent as L1/L2/L3 signaling using, for example, a UE specific Physical Random Access Channel (PRACH) resource dedicated to this purpose, or UE assistance information (UAI). The UE may be configured to omit radio link failure (RLF) reporting.

Information relating to a primary cell operation only and a secondary cell de-configuration or de-activation. In other words, he UE in the RRC connected state should consider all SCells de-configured/de-activated at once, and there is no service/communication via the secondary cell.
Information relating to a cell-wise connected mode discontinuous reception (C-DRX) configuration. (i.e. whether the UE in the RRC connected state should overwrite its UE-specific C-DRX configuration with the cell-specific one). Further, in the C-DRX configuration all UEs now apply the same DRX configuration (it can be DRX for Idle UEs and/or DRX for Connected UEs).
Information relating to a cell discontinuous reception (DRX) or cell discontinuous transmission (DTX) pattern. The cell DRX and/or cell DTX may apply to any signal or subset of signals, for example, network configured signals.
Information relating to a configured grant (CG)/semi-persistent scheduling (SPS) configurations. For example, the UE may be configured to discard all semi-persistent resources for the UE, including discarding all or selected CSI-RS configurations of the UE, and discarding of all CG and SPS configurations of the UE.
Information relating to voice and small data transmission (SDT) only mode. For uplink (UL) payload exceeding the SDT data amount threshold (either the legacy threshold or a dedicated threshold for emergency), the UE cannot initiate access to the network. For downlink (DL), the gNB will discard payloads larger than a network internal data amount threshold. In case of voice call, the UE is allowed to start an ordinary connection, i.e. the UE can perform the call.
Information relating to immediate and implicit suspension or release of the radio resource control connection. This may be done without an explicit RRC release message, and the UE be configured to move to the radio resource control idle or inactive state. If the network emergency mode configuration comprises a suspend configuration, the UE may move to the inactive state, and otherwise to the idle state.

In an example embodiment, the gNB may transmit an activation indication associated with the network £ emergency mode configuration to the UE, and apply the network emergency mode configuration in response to transmitting the activation indication. In an example embodiment, gNB may be configured to send an indication, for example, in the paging downlink control information (DCI) short message to enable the network emergency mode configuration. For example, a spare bit in the DCI short message may be used for this. In another example embodiment, the activation of the network emergency mode configuration may be indicated in the system information block type 1 (SIB1 ) or in the master information block (MIB) so that new UEs entering a cell are aware of the current cell configuration. Once the network emergency mode configuration is enabled by the activation indication, the network emergency mode configuration may be used until the gNB transmits a new explicit indication that disables the network emergency mode configuration to the UE. In another example embodiment, the network emergency mode configuration may comprise the activation indication (thus being explicitly indicated) or the network emergency mode configuration may act as the activation indication (thus being an implicit activation indication).

In an example embodiment, upon the network emergency mode activation, the gNB may be configured to discard transmission of the paging early indication (PEI) signal and/or the tracking reference signal (TRS) for a UE being in a radio resource control idle or inactive state such that gNB only transmits synchronization signal/PBCH blocks (SSB) and regular paging.

In an example embodiment, the network emergency mode configuration may comprise at least one of an indication of at least one affected cell and cell availability period information of the at least one affected cell, and an indication that at least one frequency layer is unavailable and unavailability information when the at least one frequency layer is unavailable. This may then cause the UE to limit network access or network signaling in accordance with cell availability period information when the an affected cell was the last serving cell of the UE. The affected cells may be indicated to the UE with an emergency cell list. The cell availability period information may indicate a time interval t1-t2 during which network access or network signaling is allowable. Thus, the gNB may be configured to switch off network services outside the cell availability period. The time interval t1-t2 may be, for example, 5 minutes in every 30 minutes or 5 minutes in every 60 minutes. The UE served by the affected cell will then postpone network access or network signaling until the next time interval t1-t2 period, and sleep outside the time intervals t1-t2.

The use of cell availability periods may enable a tradeoff in which the network still allows to transfer simple messages once per hour, and at the same time the battery duration both at the UE and the gNB is extended.

In an example embodiment, outside the time interval t1-t2), network services may be switched off (with no SSB transmissions). Further, in an example embodiment, network access may be barred for UEs outside the cell availability period based on at least one terminal apparatus class. This may be used, for example, to ensure that authorities and other people belonging to an emergency class are able to access the network during the emergency situation.

In an example embodiment, the gNB may be configured to indicate if the SIB has changed since last network availability period, and if there is no change, the UE can attempt network access without reading the SIB. For example, the valueTag parameter may be used to indicate whether SIB has changed.

As the cell availability period may be short and off periods may be long, traffic may accumulate in the UEs in a way that the gNB may not be able to serve all the requests during the short awake intervals. In an example embodiment, the gNB may be configured to need to prioritize the traffic or impose some limitations on the amount of time, resources and/or data rate for each UE. In another example embodiment, the gNB may be configured to act based on best effort basis and serve all the traffic that is able to in such interval. The best effort solution may also be combined with the prioritizing solution.

In an example embodiment, when the network emergency is declared, the gNB may be configured first to apply a softer network emergency mode configuration, for example, by allowing calls, first responders, rescuers etc. Then, the trigger conditions for a stricter extreme mode configuration comprising at least one of the time interval solution, prioritization solution and best effort solution, to be applied may relate to critical levels of batteries (for example, when the battery level is below a threshold) and/or a time threshold (for example, a predetermined number of hours) since the network emergency was declared.

In an example embodiment, the gNB may be configured to apply a first transmission power level during a first part of the cell availability period, determine, based on measurement reports from UEs, a second transmission power level to be used during a second part of the cell availability period, and apply the second transmission power level during the second part of the cell availability period. For example, if the gNB determines that most of the UEs (or a high percentage of them) are in a cell center, the gNB may be configured to reduce the transmission power for the rest of the time interval, thus saving a substantial amount of energy. On the other hand, if many UEs are located in a cell edge, the gNB may be configured to maintain high transmit power during the whole time interval.

In an example embodiment, the gNB may configured to transmit access barring information associated with the network emergency mode configuration to the terminal apparatus. Further, the gNB may be configured to apply the access barring information and unified access control when network access is available.

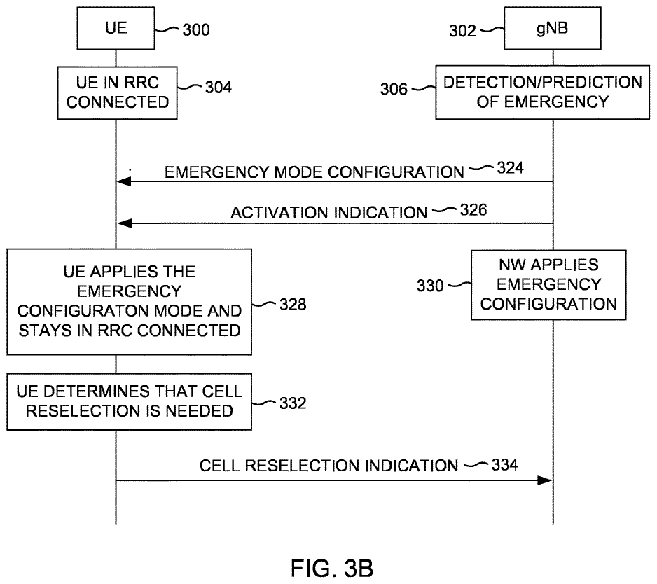

FIG. 3A illustrates a flow diagram according to an example embodiment. FIG. 3A illustrates an example embodiment for the signaling between a UE 300 and a gNB 302 relating to a network emergency mode configuration.

At 304 it is indicated that the UE 300 operates in the RRC connected state. At some point of time, the gNB 302 may detect or predict a network emergency. The network emergency may refer to a situation in which the gNB 302 is not any more able to provide a normal service to the UE 300 due to, for example, the loss of electricity grid supply to the gNB 302. Instead of an actual detection, the gNB 302 may act also based on a disaster prediction likelihood.

At 308 the gNB 302 is configured to transmit a network emergency mode configuration to the UE 300. In this example embodiment, the network emergency mode configuration comprises a suspend configuration, an indication of an autonomous RRC connection release and voice and small data transmission (SDT) only mode indication. The network emergency mode configuration may the transmitted to the UE 300 together with the first RRC configuration or in the SIB. In another example embodiment, the network emergency mode configuration may the transmitted to the UE 300 based on the disaster prediction likelihood and only for affected gNBs. In such a case, the network emergency mode configuration is sent both with the first RRC configuration and in the SIB. In an example embodiment, the network emergency mode configuration may be provided via system information (SI) as well for UEs from other public land mobile networks (PLMN) that are roaming in case of a disaster. In another example embodiment, the network emergency mode configuration of different PLMNs can be provided by the home PLMN (HPLMN) before the HPLMN has to shut down its operations due to no electricity.

The network emergency mode configuration may be a cell specific or a cell type specific configuration. Different network emergency mode configurations to adapt each parameter of the cell type, for example, the transmit power, may depend on the cell size. Different cell types or categories may also be defined to share the same different network emergency mode configuration, for example, large, medium and small cells.

In another example embodiment, the network emergency mode configuration may be frequency layer specific. For example, only a coverage layer (<1 GHz) may be kept on while higher frequency capacity layers may be switched off. This can be accompanied with a change of frequency layer specific priorities and/or ranking, to steer the UEs to the main coverage layer.

In another example embodiment, the network emergency mode configuration may be common for the network. The network emergency mode configuration may comprise parameters that can be configured in common for all cells, for example, SSB periodicity, suspension of certain services or features (for example, IoT, RedCap etc.).

In another example embodiment, each UE may be provided with a general network emergency mode configuration which includes the subset of network common parameters and a cell specific network emergency mode configuration which includes the dependent parameters.

Further, in an example embodiment, the gNB 302 benefits the most when there are a limited number of UEs 300 in the RRC connected state when the network emergency mode configuration is activated as the portion of energy used by the gNB 302 for broadcast should be minimized.

In another example embodiment, the network emergency mode configuration may comprise at least one of the following:
Long DRX cycle value for paging, covering also a possibility to a fall-back eDRX based operation.
Infrequent periodicity of transmitted control channels (for example, SSB, SI) or even no transmission of some SIBs (for example, relating to inter-RAT mobility, sidelink or other specific services like the multicast/broadcast service (MBS). The SIB1 may indicate that remaining SIBs are on-demand.
Infrequent periodicity of received control channels (for example, PRACH occasions).
Reduced radio configurations (for example, low subcarrier spacing (SCS) value, a change in number of SSBs with corresponding change in applied broadcast beamforming, low number of MIMO layers, low TX power, small initial bandwidth, small dedicated bandwidth).
Limited/relaxed radio measurements for RRM, radio link management (RLM) and beam failure detection (BFD) measurements, change of the associated reference resources and/or modified conditions to trigger, for example, RLM/RLF.

When a network emergency occurs, at 310 the gNB 302 is configured to transmit an activation indication of the network emergency mode configuration to the UE 300. After transmitting the activation indication, the gNB 302 starts to apply the network emergency mode configuration at 314. In response to receiving the activation indication, the UE 300 is configured to start applying the network emergency mode configuration, release the RRC connection and move to an RRC inactive state at 312. In an example embodiment, the gNB 302 may send the activation indication, for example, e in the paging downlink control information (DCI) short message to enable the network emergency mode configuration. For example, a spare bit in the DCI short message may be used for this. In another example embodiment, the activation of the network emergency mode configuration may be indicated in the system information block type 1 (SIB1 ) or in the master information block (MIB) so that new UEs entering a cell are aware of the current cell configuration. As a result, the UE 300 is now in the RRC inactive state, as indicated by the reference 316.

FIG. 3A illustrates two different embodiments how the UE 300 may proceed after this. In the first embodiment at 318, the UE 300 has data to be transmitted to the gNB 302, but as configured by the network emergency mode configuration, it is only allowed to use SDT for data. Due to this, the UE 300 discards the payload because it exceeds the SDT data amount threshold.

In the second embodiment, the UE 300 has data to be transmitted to the gNB 302, and the payload does not exceed the SDT data amount threshold. Due to this, the UE 300 determines that it can use the SDT for transmitting the data. At 322 the UE 300 is configured to perform the data transmission using the SDT.

FIG. 3B illustrates a flow diagram according to another example embodiment. FIG. 3B illustrates an example embodiment for the signaling between a UE 300 and a gNB 302 relating to a network emergency mode configuration.

At 304 it is indicated that the UE 300 operates in the RRC connected state. At some point of time, the gNB may detect or predict a network emergency. The network emergency may refer to a situation in which the gNB 302 is not any more able to provide a normal service to the UE 300 due to, for example, the loss of electricity grid supply to the gNB 302. Instead of an actual detection, the gNB 302 may act also based on a disaster prediction likelihood.

At 324 the gNB 302 is configured to transmit a network emergency mode configuration to the UE 300. In this example embodiment, the network emergency mode configuration comprises a release indication of semi-persistent resources (for example, CG, SPS and CSI-RS) and voice and small data transmission (SDT) only mode indication. The network emergency mode configuration may the transmitted to the UE 300 together with the first RRC configuration or in the SIB. In another example embodiment, the network emergency mode configuration may the transmitted to the UE 300 based on the disaster prediction likelihood and only for affected gNBs. In such a case, the network emergency mode configuration is sent both with the first RRC configuration and in the SIB. In an example embodiment, the network emergency mode configuration may be provided via system information (SI) as well for UEs from other public land mobile networks (PLMN) that are roaming in case of a disaster. In another example embodiment, the network emergency mode configuration of different PLMNs can be provided by the home PLMN (HPLMN) before the HPLMN has to shut down its operations due to no electricity.

The network emergency mode configuration may be a cell specific or a cell type specific configuration. Different network emergency mode configurations to adapt each parameter of the cell type, for example, the transmit power, may depend on the cell size. Different cell types or categories may also be defined to share the same different network emergency mode configuration, for example, large, medium and small cells.

In another example embodiment, the network emergency mode configuration may be frequency layer specific. For example, only a coverage layer (<1 GHz) may be kept on while higher frequency capacity layers may be switched off. This can be accompanied with a change of frequency layer specific priorities and/or ranking, to steer the UEs to the main coverage layer.

In another example embodiment, the network emergency mode configuration may be common for the network. The network emergency mode configuration may comprise parameters that can be configured in common for all cells, for example, SSB periodicity, suspension of certain services or features (for example, IoT, RedCap etc.).

In another example embodiment, each UE may be provided with a general network emergency mode configuration which includes the subset of network common parameters and a cell specific network emergency mode configuration which includes the dependent parameters.

Further, in an example embodiment, the gNB 302 benefits the most when there are a limited number of UEs 300 in the RRC connected state when the network emergency mode configuration is activated as the portion of energy used by the gNB 302 for broadcast should be minimized.

In another example embodiment, the network emergency mode configuration may comprise at least one of the following:
Long DRX cycle value for paging, covering also a possibility to a fall-back eDRX based operation.
Infrequent periodicity of transmitted control channels (for example, SSB, SI) or even no transmission of some SIBs (for example, relating to inter-RAT mobility, sidelink or other specific services like the multicast/broadcast service (MBS). The SIB1 may indicate that remaining SIBs are on-demand.
Infrequent periodicity of received control channels (for example, PRACH occasions).
Reduced radio configurations (for example, low subcarrier spacing (SCS) value, a change in number of SSBs with corresponding change in applied broadcast beamforming, low number of MIMO layers, low TX power, small initial bandwidth, small dedicated bandwidth).
Limited/relaxed radio measurements for RRM, radio link management (RLM) and beam failure detection (BFD) measurements, change of the associated reference resources and/or modified conditions to trigger, for example, RLM/RLF.

When a network emergency occurs, the gNB 302 is configured to transmit an activation indication at 326 of the network emergency mode configuration to the UE 300. After transmitting the activation indication, the gNB 302 starts to apply the network emergency mode configuration at 330. In response to receiving the activation indication, the UE 300 is configured to start applying the network emergency mode configuration and stay in the RRC connected state at 328. In an example embodiment, the gNB 302 may send the activation indication, for example, in the paging downlink control information (DCI) short message t enable the network emergency mode configuration. For example, a spare bit in the DCI short message may be used for this. In another example embodiment, the activation of the network emergency mode configuration may be indicated in the system information block type 1 (SIB1 ) or in the master information block (MIB) so that new UEs entering a cell are aware of the current cell configuration. As a result, the UE 300 is now in the RRC inactive state, as indicated by the reference 316.

At 332 the UE 300 determines that cell reselection is needed. In response to the determination, at 334 the UE 300 is configured to transmit a cell reselection indication to the gNB 302.

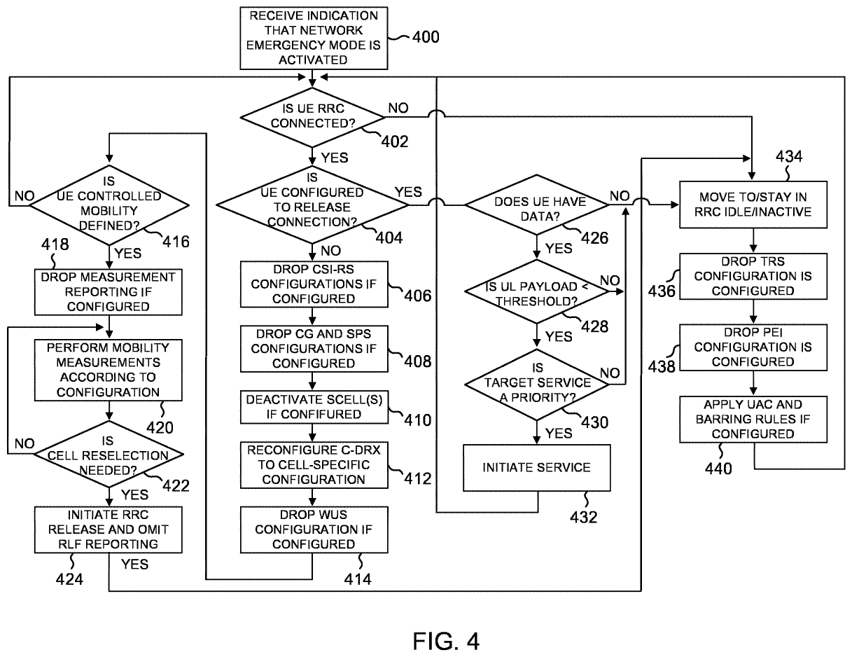

FIG. 4 illustrates a flow diagram for a terminal apparatus, for example, a UE according to an example embodiment. FIG. 4 assumes that the UE has received from a network apparatus, for example, a base station or a gNB a network emergency mode configuration, the network emergency mode configuration indicating at least one reduced operation mode to be applied in response to a network emergency.

At 400 the UE receives an activation indication from the network for the network emergency mode configuration. Depending on the UE's RRC state and traffic profile, the UE performs different actions.

If it is determined at 402 that the UE is not in the RRC connected state, the processing proceeds to step 434. At 434 the UE is configured to move to or stay in the RRC idle/inactive state. At 436 the UE is configured to drop the tracking reference signal (TRS) configuration if configured. At 438 the UE is configured to drop the paging early indication (PEI) signal is configured.

At 440 the UE is configured to apply unified access control (UAC) and barring rules if configured. The gNB may transmit to the UE a SIB1: UAC Config message. The message may determine an access category (AC) that depends on a service type and an access identity (AI) that depends on UE profile as per standardized information or per information stored in the USIM. For example, AIs 0-9 are for normal UEs and AIs 11-15 are for high priority UEs. The barring information includes the following parameter for each AI:
A barring indicator informing whether the access attempt is allowed for this AI.
A barring factor indicating the probability that the given access request can be allowed
A barring time defining the minimum time interval before a new access attempt can be performed after it was barred.

If the UE was determined to be in the RRC connected state at 402, the processing proceeds to 404. At 404 it is determined whether the UE is configured to release the RRC connection. If the UE is configured to release the RRC connection, the processing proceeds to 426. At 426 it is determined whether the UE has data to be transmitted. If there is no data to be transmitted, the processing proceeds to 434. If there is data to be transmitted, the processing proceeds to 428. At 428 it is determined whether the uplink payload exceeds a threshold. If the uplink payload does not exceed the threshold, the processing proceeds to 434. If the uplink payload exceeds the threshold, the processing proceeds to 430. At 430 it is determined whether the target service has a priority. If it is determined that the target service has no priority, the processing proceeds to 434. If it is determined that the target service has priority, the processing proceeds to 432 where the service is initiated.

If at 404 it is determined that the UE is not configured to release the RRC connection, the processing proceeds to 406. At 406 CSI-RS configurations are dropped if configured. The dropped CSI-RS configurations may exclude those CSI-RS resources that are configured with higher layer parameter trs-Info. Instead of dropping these maybe kept unchanged, or the periodicity of these resources can be extended to value configured by network. At 408 CG and SPS configurations are dropped if configured. At 410 Scell(s) is (are) deactivated if configured. At 412 C-DRX is reconfigured to cell-specific configuration. At 414 WUS configuration is dropped if configured.

At 416 it is determined whether UE controlled mobility is defined. If UE controlled mobility is not defined, the processing returns back to step 402. If UE controlled mobility is defined, the processing proceeds to 418. At 418 measurement reporting is dropped if configured. At 420 mobility measurements are performed according to the configuration. At 422 it is determined whether cell reselection is needed. If it is determined that cell reselection is not needed, the processing returns back to step 420. If it is determined that cell reselection is needed, the processing proceeds to 424. At 424 RRC release is initiated and RLF reporting is omitted. After this, the processing proceeds to 434.

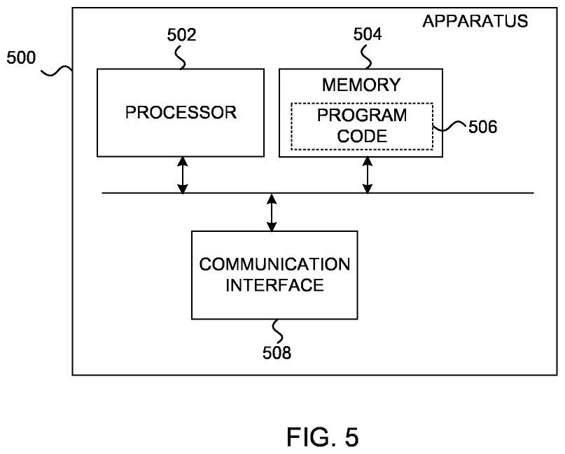

FIG. 5 illustrates an example of an apparatus 500 configured to practice one or more example embodiments. The apparatus 500 may comprise, for example, an access node, a base station, a gNB, a radio network node or a split portion thereof, a user node, a user equipment, or in general a device configured to implement the functionality described herein. Although the apparatus 500 is illustrated as a single device, it is appreciated that, wherever applicable, functions of the apparatus 500 may be distributed to a plurality of devices.

The apparatus 500 may comprise at least one processor 502. The at least one processor 502 may comprise, for example, one or more of various processing devices or processor circuitry, such as, for example, a co-processor, a microprocessor, a controller, a Digital Signal Processor (DSP), a processing circuitry with or without an accompanying DSP, or various other processing devices including integrated circuits such as, for example, an Application Specific Integrated Circuit (ASIC), a Field Programmable Gate Array (FPGA), a Microcontroller Unit (MCU), a hardware accelerator, a special-purpose computer chip, or the like.

The apparatus 500 may further comprise at least one memory 504. The at least one memory 504 may be configured to store, for example, computer program code or the like, for example, operating system software and application software. The at least one memory 504 may comprise one or more volatile memory devices, one or more non-volatile memory devices, and/or a combination thereof. For example, the at least one memory 504 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 500 may further comprise a communication interface 508 configured to enable the apparatus 500 to transmit and/or receive information to/from other devices. In one example, the apparatus 500 may use the communication interface 508 to transmit or receive signaling information and data in accordance with at least one data communication or cellular communication protocol. The communication interface 508 may be configured to provide at least one wireless radio connection, such as, for example, a 3GPP mobile broadband connection (e. g. 3G, 4G, 5G, 6G etc.). The communication interface 508 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. The communication interface 508 may comprise a receiver, a transmitter or a transceiver.

When the apparatus 500 is configured to implement some functionality, some component and/or components of the apparatus 500, for example, the at least one processor 502 and/or the at least one memory 504, may be configured to implement this functionality. Furthermore, when the at least one processor 502 is configured to implement some functionality, this functionality may be implemented using the program code 506 comprised, for example, in the at least one memory 504.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described herein. The program code 506 is provided as an example of instructions which, when executed by the at least one processor 502, cause performance of apparatus. Alternatively, or in addition, the functionality described herein can be performed, at least in part, by one or more hardware logic components. For example, and without limitation, illustrative types of hardware logic components that can be used include Field-programmable Gate Arrays (FPGAS), Application-Specific Integrated Circuits (ASICs), Application-Specific Standard Products (ASSPs), System-on-a-chip systems (SOCs), Complex Programmable Logic Devices (CPLDs), and Graphics Processing Units (GPUS).

The apparatus 500 may be configured to perform or cause performance of any aspect of the method(s) described herein, for example, the functions executed by the UE 300 or the gNB 302. Further, a computer program may comprise instructions for causing, when executed, an apparatus to perform any aspect of the method(s) described herein. The computer program may be stored on a computer-readable medium. Further, the apparatus 500 may comprise means for performing any aspect of the method(s) described herein. In one example, the means may comprise the at least one processor 502, the at least one memory 504 including the program code 506 (instructions) configured to, when executed by the at least one processor 502, cause the apparatus 500 to perform the method(s). In general, computer program instructions may be executed on means providing generic processing functions. The method(s) may be thus computer-implemented, for example based algorithm(s) executable by the generic processing functions, an example of which is the at least one processor 502. The means may comprise transmission and/or reception means, for example one or more radio transmitters or receivers, which may be coupled or be configured to be coupled to one or more antennas, or transmitter(s) or receiver(s) of a wired communication interface.

One or more of the above discussed examples and embodiments may enable a solution allowing a timely and efficient switch to low power mode in case of the network emergency. This also in power saving both for the UE and the gNB. Further, one or more of the above discussed examples and embodiments may enable a solution that minimizes the number of slots with downlink transmissions, which are the most power consuming, and at the same time the transmission power for those slots is reduced. Further, one or more of the above discussed examples and embodiments may enable a solution that allows the gNB and UE to efficiently adapt to the maximum current that can be drawn when switching to batteries as a power source. Further, one or more of the above discussed examples and embodiments may enable a solution in which the power saving will allow to extend the battery duration which is of vital importance in emergency situations in which the power grid may be down for a long time.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1-15. (canceled)

16. A terminal apparatus comprising:
at least one processor; and
at least one memory storing instructions, that when executed by the at least one processor, cause the terminal apparatus to perform:
receiving a network emergency mode configuration, the network emergency mode configuration indicating at least one reduced operation mode to be applied in response to an activation indication; and
applying the at least one reduced operation mode for network signaling based on the network emergency mode configuration; wherein the network emergency mode configuration comprises:
an indication of at least one affected cell and cell availability period information of the at least one affected cell; and wherein the instructions, when executed by the at least one processor, cause the terminal apparatus to perform omitting measurements of the at least one affected cell and cell detections for the at least one affected cell outside the cell availability period; and wherein the cell availability period information indicates a time interval t1-t2 during which network access or network signaling is allowable, wherein the terminal apparatus UE served by the affected cell is configured to postpone network access or network signaling until the next time interval t1-t2, and sleep outside the time intervals t1-t2, and when the network is available again, to first search for the last serving cell.

17. The terminal apparatus according to claim 16, wherein the instructions, when executed by the at least one processor, cause the terminal apparatus to perform:
receiving the network emergency mode configuration via dedicated radio resource control signaling or a system information broadcast.

18. The terminal apparatus according to claim 16, wherein the instructions, when executed by the at least one processor, cause the terminal apparatus to perform:
receiving the activation indication associated with the network emergency mode configuration; and
applying the network emergency mode configuration based on the activation indication.

19. The terminal apparatus according to claim 16, wherein the network emergency mode configuration comprises the activation indication or the network emergency mode configuration acts as the activation indication.

20. The terminal apparatus according to claim 16, wherein the network emergency mode configuration comprises at least one of:
information relating to UE controlled L1 and/or L3 mobility;
information relating to a primary cell operation only and a secondary cell de-configuration or de-activation;
information relating to a cell-wise connected mode discontinuous reception configuration of the terminal apparatus;
information relating to a cell discontinuous reception or transmission pattern;
information relating to a configured grant/semi-persistent scheduling configurations;
information relating to voice and small data transmission only mode; and
information relating to immediate and implicit suspension or release of the radio resource control connection.

21. The terminal apparatus according to claim 20, wherein the instructions, when executed by the at least one processor, cause the terminal apparatus to perform at least one of the following based on the presence of the corresponding information in the network emergency mode configuration:
applying terminal apparatus controlled L1 and/or L3 mobility in response to the information relating to terminal apparatus controlled L1 and/or L3 mobility;
de-configuring or deactivating all configured secondary cells in response to the information relating to a primary cell operation only and a secondary cell de-configuration or de-activation;
applying a cell-wise connected mode discontinuous reception configuration in response to the information relating to a cell-wise connected mode discontinuous reception configuration of the terminal apparatus;
applying a cell discontinuous reception or transmission pattern in response to the information relating to a cell discontinuous reception or transmission pattern;
discarding all semi-persistent resources for the UE and configured grant and semi-persistent scheduling configurations in response to the information relating to a configured grant and semi-persistent scheduling configurations;
applying voice and small data transmission only mode in response to the information relating to voice and small data transmission only mode; and
releasing the radio resource control connection in response to the information relating to immediate and implicit suspension or release of the radio resource control connection, and moving to an inactive or idle state.

22. The terminal apparatus according to claim 16, wherein the instructions, when executed by the at least one processor, cause the terminal apparatus to perform:
omitting reception or discarding configuration of the paging early indication signal and/or the tracking reference signal when the terminal apparatus is in radio resource control idle or inactive state.

23. The terminal apparatus according to claim 16, wherein the network emergency mode configuration comprises at least one of:
an indication of at least one affected cell and cell availability period information of the at least one affected cell; and
an indication that at least one frequency layer is unavailable and unavailability information when the at least one frequency layer is unavailable.

24. The terminal apparatus according to claim 23, wherein the instructions, when executed by the at least one processor, cause the terminal apparatus to perform:
limiting network signaling in accordance with the cell availability period information when an affected cell was the last serving cell of the terminal.

25. The terminal apparatus according to claim 23, wherein the instructions, when executed by the at least one processor, cause the terminal apparatus to perform:
applying a random delay for setting up a connection with a target cell in the beginning of the cell availability period.

26. The terminal apparatus according to claim 23, wherein the instructions, when executed by the at least one processor, cause the terminal apparatus to perform at least one of:
omitting measurements of the at least one affected cell and cell detections for the at least one affected cell outside the cell availability period; and
omitting measurements of the at least one frequency layer based on the unavailability information.

27. A network apparatus comprising:
at least one processor; and
at least one memory storing instructions, that when executed by the at least one processor, cause the network apparatus to perform:
transmitting a network emergency mode configuration to a terminal apparatus, the network emergency mode configuration indicating at least one reduced operation mode to be applied in response to an activation indication; and
applying the at least one reduced operation mode based on the network emergency mode configuration.

28. A method comprising:
receiving, by a terminal apparatus, a network emergency mode configuration, the network emergency mode configuration indicating at least one reduced operation mode to be applied in response to an activation indication; and
applying, by the terminal apparatus, the at least one reduced operation mode for network signaling based on the network emergency mode configuration.

29. A method comprising:
transmitting, by a network apparatus, a network emergency mode configuration to a terminal apparatus, the network emergency mode configuration indicating at least one reduced operation mode to be applied in response to an activation indication; and
applying, by the network apparatus, the at least one reduced operation mode based on the network emergency mode configuration.
